(19) United States
(12) Patent Application Publication
(10) Pub. No.: US 2018/0119608 A1
(43) Pub. Date: May 3, 2018

(54) ACTUATING A GAS TURBINE BY MEANS OF A PULSATING GAS FLOW

(71) Applicant: Galin Stefanov RAYCHINOV, Sofia (BG)

(72) Inventor: Galin Stefanov RAYCHINOV, Sofia (BG)

(21) Appl. No.: 15/572,305

(22) PCT Filed: Apr. 28, 2016
(86) PCT No.: PCT/BG2016/000011

§ 371 Date: Nov. 7, 2017

(30) Foreign Application Priority Data
May 8, 2015 (BG) 112010

(51) Int. Cl. F02B 37/24

(52) U.S. Cl. CPC F02B 37/24

(57) ABSTRACT

A system for actuating a gas turbine by means of a pulsating gas flow, which comprices of a source of pulsating gas flow, connected to an inlet of a gas turbine, the shaft of which is connected to at least one consumer of mechanical energy, is characterized in that it includes at least one sensor of the instantaneous parameters of the pulsating gas flow at the turbine inlet, said sensor being connected to a controller which is connected to a device for controlling the load on the consumer of mechanical energy. The method and system constituting the subject matter of the invention provide for increased gas turbine efficiency and a reduced drag of the same to the pulsating gas flow that is supplied to it.

### TECHNICAL FIELD

The subject of the invention is a method and system for driving a gas turbine by a pulsating gas flow. The invention finds application mainly in the manufacture and operation of internal combustion engines.

### BACKGROUND

Widely known in technology and, in particular, in engine building, are the method and systems of driving a gas turbine by a pulsating gas flow.

In the already known method, a pulsating gas flow is supplied to the gas turbine, which transforms the energy of the gas flow into mechanical energy of the turbine shaft, which is supplied to the consumer of mechanical energy. In the already known method, known are controls that relate to the total flow of the pulsating gas flow or its angle of attack on the gas turbine blades. There is no known method for controlling the load of the consumer of mechanical energy according to the instantaneous parameters of the pulsating gas flow. Known systems consist of a source of a pulsating gas flow—for example, an internal combustion engine (ICE) whose exhaust pipe is connected to an inlet of a gas turbine whose shaft is connected to at least one user of mechanical energy—for example, an electric generator or a hydraulic pump. Additional components for adjusting the system according to the needs of the power consumer's mechanical energy, such as a bypass valve at the inlet of the gas turbine, reducing the total flow rate of the gas flow to the gas turbine, or controlled blades guiding the gas flow that change its angle of attack on the gas turbine blades.

The described systems and method have one main lack. The supply of a pulsating gas flow, which is the exhaust gas flow from the internal combustion engine with consecutive cyclic operating cycles, significantly reduces the efficiency of the gas turbine compared to its efficiency when supplied with a steady gas flow, and increases the drag of the exhaust system of the internal combustion engine, which leads to a decrease in its power. Pulsations of the gas flow are caused by the exhausts strokes of ICE and are expressed in successive changes in pressure, velocity, density and temperature of the gas flow in the gas turbine. As a result, the efficiency of the gas turbine is continuously changing/pulsating synchronously with the pulsations of the gas flow, varying between a maximum of 80-90% and a minimum that drops even below minus 30%. That is, at certain moments the turbine not only does not convert the energy of the pulsating gas flow into the mechanical energy of the turbine shaft, but even is a consumer of the mechanical energy of the turbine shaft. At such moments, due to the fact that the turbine can not function as a pump, or if it works as a pump, then with very low efficiency, the turbine continues to slow down the gas flow, although it applies mechanical energy from the inertia of the shaft and the consumer of mechanical energy to the gas flow. As a result of the above, the average weighted efficiency of the turbine is significantly lower than the efficiency when operating with a steady/non-pulsating gas flow, while, at the same time, drag to the gas flow passing through the turbine does not decrease in proportion to the reduced average weighted efficiency of the turbine.

### SUMMARY

It is an object of the present invention to provide a method and system for actuating a gas turbine by means of a pulsating gas flow in order to provide increased efficiency of a gas turbine and reduction of the drag of the gas turbine with respect to the pulsating gas flow.

The solution according to the invention is found by a method of actuating a gas turbine by means of a pulsating gas flow in which a pulsating gas flow is supplied to the gas turbine. The method is characterized in that, in accordance with the instantaneous parameters of the pulsating gas flow at the entrance to the gas turbine, the load on the shaft of the gas turbine is turned on or increases at moments in which the instantaneous parameters of the pulsating gas flow can provide the turbine efficiency above a predetermined value, and at moments when the instantaneous parameters of the pulsating gas flow can not provide the desired turbine efficiency, the load on the turbine shaft is turned off or reduced.

The solution according to the invention is also found by system for actuating a gas turbine by means of a pulsating gas flow that is specially designed to perform the method according to the invention, which system consists of: a source of a pulsating gas flow connected to the inlet of a gas turbine whose shaft is connected to at least one consumer of mechanical energy, characterized in that it includes at least one sensor for the instantaneous parameters of the pulsating gas flow at the inlet of the turbine, that is connected to a controller, which is connected to a device for controlling the load of the consumer of mechanical energy.

The advantages of the method and system according to the invention that are obtained as a result of the problem solving are: increased gas turbine efficiency and reduced drag of the gas turbine to the pulsating gas flow.

### BRIEF DESCRIPTION OF THE DRAWINGS

FIG. 1 is a block diagram of the system according to the invention according to the second claim.

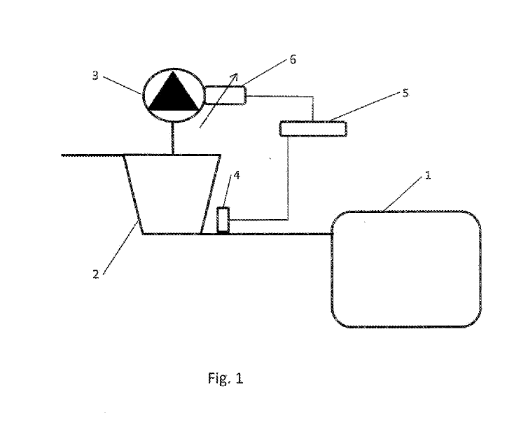

### EXAMPLES OF IMPLEMENTATION/PREFERRED EMBODIMENTS

The method of actuating a gas turbine gas turbine by means of a pulsating gas flow according to the invention is carried out in the following manner

By the respective sensor is monitored one of the instantaneous parameters of the pulsating gas flow at the inlet of the gas turbine—for example, the instantaneous pressure. When the values of the parameters are dropped below the preset values, the gas turbine shaft load is switched off or at least reduced. Accordingly, the gas turbine does not convert or convert less of the instantaneous thermal and/or kinetic energy of the pulsating gas flow into mechanical energy of its shaft. As a result, at such moments the gas turbine has a greatly reduced drag to the pulsating gas flow and thus does not prevent the passage of the corresponding relatively lower energy portion of the gas flow. At the moments when the instantaneous parameters of the pulsating gas flow increase above the preset values, the load on the shaft of the gas turbine is turned on or increased. Accordingly, the gas turbine starts/increases converting the thermal and/or kinetic energy of the respective relatively higher energy portion of the gas flow into the mechanical energy of its shaft and supplies it to the respective consumer of mechanical energy. The efficiency of the gas turbine at such moments is about its maximum efficiency. Thanks to this, the increased drag that the gas turbine causes to the pulsating gas flow at such moments is justified in view of the benefits of the correspondingly extracted mechanical energy.

In a preferred embodiment of the system according to the invention, it consists of a source of pulsating gas flow, for example an exhaust pipe of the combustion engine 1 connected to the inlet of a gas turbine 2 whose shaft is connected to at least one mechanical energy consumer 3, for example an electric generator or hydraulic pump. The system is characterized in that it includes at least one sensor 4 for the instantaneous parameters of the pulsating gas flow at the inlet of the turbine coupled to a controller 5 which is also connected to a device 6 for controlling the load of the mechanical energy consumer, respectively: a controllable limiter of the current when the mechanical energy consumer is an electric generator or when the mechanical energy consumer is a hydraulic pump—a controllable bypass valve connecting the outlet of the pump with its inlet.

### USE OF THE INVENTION

The system works the following way.

The sensor 4 monitors at least one of the instantaneous parameters of the pulsating gas flow at the inlet of the gas turbine 2—e.g., the instantaneous pressure. When the parameter values are lowered, for example, the instantaneous pressure under predefined value, the corresponding signal of the sensor 4 is registered by the controller 5. Upon this registration, the controller according to the program operating therein sends the corresponding control signal to the device 6 for controlling the load of the mechanical energy consumer 3. The device 6 accordingly reduces or completely disables the load of the mechanical energy consumer 3. In the case where the mechanical energy consumer 3 is an electric generator, the device limits or completely stops the current generated by it. If the mechanical energy consumer 3 is a hydraulic pump, the device opens the controllable bypass valve connecting the pump outlet to the pump inlet and thus allows the hydraulic fluid in the hydraulic pump to return freely or with reduced drag from the discharge outlet of the pump to its suction inlet. In both cases (electric generator and hydraulic pump), the shaft load of the gas turbine 2 is reduced or eliminated by the described methods, whereby the gas turbine 2 has reduced or no drag to the corresponding low energy portion of the pulsating gas flow.

1. A method of driving a gas turbine by a pulsating gas flow, wherein a pulsating gas flow is supplied to the gas turbine, characterized in that, in accordance with the instantaneous parameters of the pulsating gas flow at the entrance to the gas turbine, the load on the shaft of the gas turbine is turned on or increased at the moments in which instantaneous parameters of the pulsating gas flow can provide the turbine efficiency above a predetermined value, and at moments when the instantaneous parameters of the pulsating gas flow could not provide a specified turbine efficiency, the load on the turbine shaft is turned off or reduced.

2. A system for driving a gas turbine by a pulsating gas flow, the system comprising:
a source of a pulsating gas flow,
a gas turbine,
at least one consumer of mechanical energy,
at least one sensor of the instantaneous parameters of the pulsating gas flow at the turbine inlet,
a controller,
a device for controlling the load of the mechanical energy consumer,
the above item connected as follows:
the source of a pulsating gas flow connected to the inlet of the gas turbine,
the shaft of the gas turbine connected to the consumer of mechanical energy (3),
the sensor of the instantaneous parameters of the pulsating gas flow at the turbine inlet connected to the controller,
the controller connected to the device for controlling the load of the mechanical energy consumer.
